(19) United States
(12) Patent Application Publication
(10) Pub. No.: US 2019/0236188 A1
(43) Pub. Date: Aug. 1, 2019

(54) QUERY OPTIMIZER CONSTRAINTS

(71) Applicant: salesforce.com, inc., San Francisco, CA (US)

(72) Inventor: William J. McKenna, Boulder, CO (US)

(21) Appl. No.: 15/885,559

(22) Filed: Jan. 31, 2018

(51) Int. Cl. G06F 17/30

(52) U.S. Cl. CPC G06F 17/30466; G06F 17/3051

(57) ABSTRACT

Techniques are disclosed relating to database query optimizers. In some embodiments, a query optimizer of a database system receives a first query including a first constraint that restricts selection of a set of execution plans available to implement the first query. The first constraint identifies, at least, a first option and a second option to implement a clause in the first query. The query optimizer evaluates, based on the first constraint, a first execution plan that includes performance of the first option and a second execution plan that includes performance of the second option. Based on the evaluating, the query optimizer selects one of the first and second execution plans to implement the first query. The query optimizer causes execution of the selected execution plan.

### BACKGROUND

### Technical Field

This disclosure relates generally to database systems, and, more specifically, to database query optimizers.

### Description of the Related Art

When a query is submitted to a database, it may express what the result of a query should be, but not how to obtain the result. As such, it may be possible to execute a query using several different approaches. For example, a query requesting a join of tables A, B, and C may be executed as 1) a join of A and B followed by a join of the result and C or 2) a join of B and C followed by a join of A and the result. Modern relational database systems typically employ a query optimizer that receives a parsed query and evaluates different execution plans to determine a plan for executing a query. This evaluation may include determining scores for each plan based on estimated computational and storage costs and selecting the plan with the best score. Accordingly, a query optimizer might provide a better score to the second plan noted above if the result of joining B and C produced a smaller temporary table than the result of joining A and B.

### BRIEF DESCRIPTION OF THE DRAWINGS

FIG. 1 is a block diagram illustrating one embodiment of a database system configured to support query optimizer constraints.

FIG. 2 is a block diagram illustrating one embodiment of an index constraint.

FIG. 3 is a block diagram illustrating one embodiment of a physical join constraint.

FIG. 4 is a block diagram illustrating one embodiment of a logical join constraint.

FIG. 5 is a block diagram illustrating one embodiment of a parameterize constraint.

FIG. 6 is a block diagram illustrating one embodiment of a cardinality constraint.

FIG. 7 is a block diagram illustrating one embodiment of a constraint merger.

FIGS. 8A and 8B are flow diagrams illustrating embodiments of methods for servicing database queries.

FIG. 9 is a block diagram illustrating one embodiment of an exemplary computer system.

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “database system configured to store data in a table” is intended to cover, for example, a computer system having one or more processors and memory having program instructions to perform this function during operation, even if the computer system in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, if a database system receives a first request and a second request, these requests can be received in any ordering. In other words, the “first” request is not limited to an initial request, for example.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

### DETAILED DESCRIPTION

Query optimizers may not always select the most desirable execution plan for a given query. This may be attributable to the fact that various cost metrics assessed by a query optimizer may include incorrect information. For example, statistics maintained for a given table (or column) may be stale or missing. It may also be difficult to accurately estimate the cost of complex queries that include multiple predicates. In contrast, a user (or an application) may have greater insight into the data stored in a database as well as the queries being submitted. Still further, a user may be able to determine that the execution plans being selected by a query optimizer for particular queries are underperforming and can be improved. As such, a query optimizer may benefit from this additional insight.

The present disclosure describes embodiments in which a query optimizer of a database system is operable to receive directives (referred to below as query optimizer constraints) that restrict the set of execution plans being considered to implement a given query. As will be described below, a query may be submitted that includes one or more embedded constraints. These constraints may then be provided to a query optimizer that evaluates various execution plans for the query and attempts to select a plan that complies with the constraints. For example, a query may include a constraint instructing the optimizer to select a plan that includes a particular type of scan, join, etc.—thus, a user may prevent a query optimizer from selecting a plan including a problematic join operation, for example. As will also be discussed, in various embodiments, the query optimizer can receive a constraint that identifies multiple options for implementing a clause/portion of a query. The query optimizer can then evaluate execution plans pertaining to the options and select a plan that includes one of the options. For example, a constraint may be submitted that indicates a particular scan should be performed using one or two of potential indexes identified in the constraint. The query optimizer may then evaluate plans that include scans using the first index and plans that include scans using the second index, and select one of the plans based on its evaluation. Thus, a user may be able to restrict what plans are being considered by the query optimizer, but still leverage the intelligence of the query optimizer to select between multiple favorable options. In various embodiments, if the query optimizer is unable to identify a plan that satisfies that the constraints in a given query, the query optimizer may still provide an indication of why it was unable to satisfy the constraints—in some embodiments, the query optimizer may even still select a noncompliant plan and have the plan executed, so that the query is still serviced.

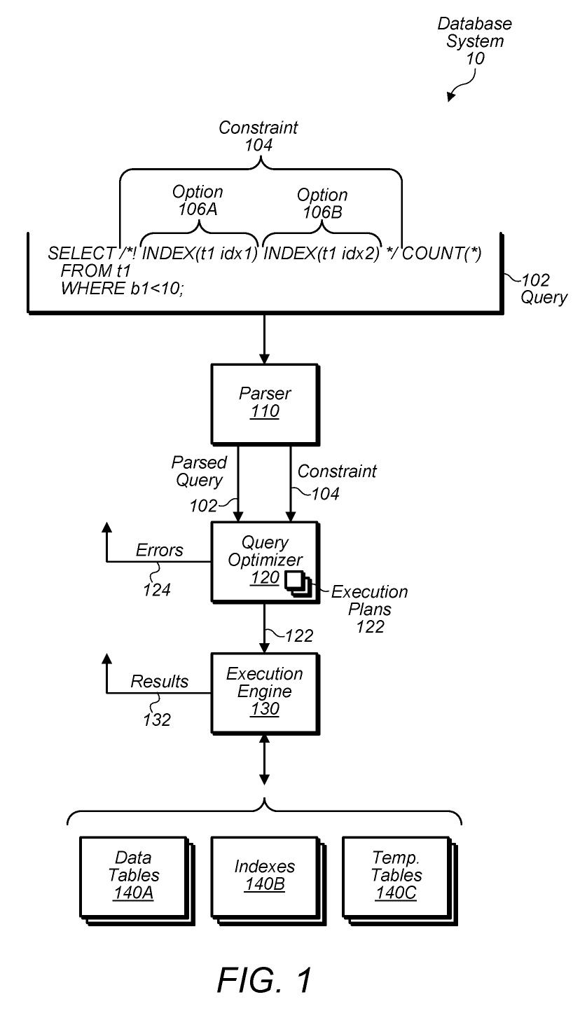

Turning now to FIG. 1, a block diagram of a database system 10 configured to support queries 102 having query optimizer constraints 104 is depicted. In illustrated embodiment, database system 10 includes a parser 110, query optimizer 120, execution engine 130, and tables 140. In some embodiments, database system 10 may be implemented differently than shown. For example, system 10 may include more components, queries 102 may be expressed using a different syntax, etc.

Database system 10 may correspond to any suitable database system. In some embodiments, system 10 is a relational database management system (RDBMS), which may be implemented using, for example, Oracle™, MySQL™, Microsoft™ SQL Server, PostgreSQL™, IBM™ DB2, etc. Accordingly, system 10 may be configured to store data in one or more data tables 140A for servicing queries 102. System 10 may also maintain one or more indexes 140B usable to facilitate retrieving data from data tables 140A, and may generate temporary tables 140C in response to servicing queries 102. In the illustrated embodiment, queries 102 are expressed using structured query language (SQL); in other embodiments, other query declarative languages may be supported.

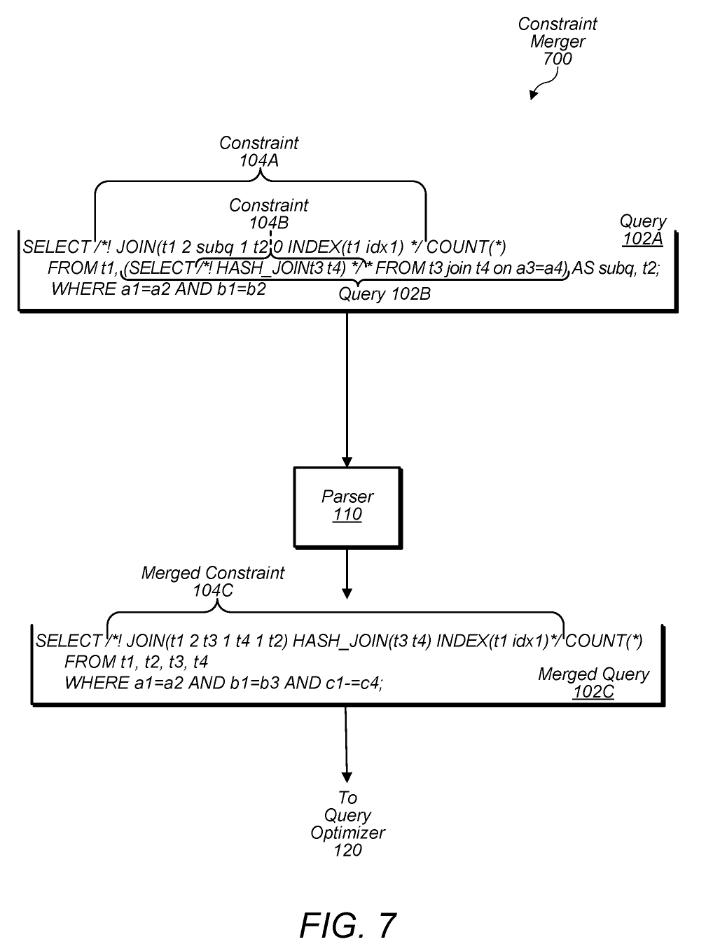

Parser 110, in various embodiments, is operable to parse a submitted query 102, which may include one or more constraints 104. In some embodiments, this parsing may include performing a syntax analysis of the clauses within a query 102 and assembling a data structure (e.g., an expression tree) that can be processed by query optimizer 120. Parser 110 may also separate any constraints 104 from the query 102. In the illustrated embodiment of FIG. 1, parser 110 identifies a constraint 104 based on the presence of the delimiter/*! . . . */, where . . . is the content of the constraint. In other embodiments, different delimiters (or even techniques) may be used to distinguish a constraint 104 from other content in query 102. As will be described with respect to FIG. 7, in some embodiments, parser 110 may also attempt to flatten queries 102 if they include subqueries. This flattening may include merging a query and a subquery into a single query as well as merging together constraints 104 if multiple constraints 104 have been specified for the query and its subquery.

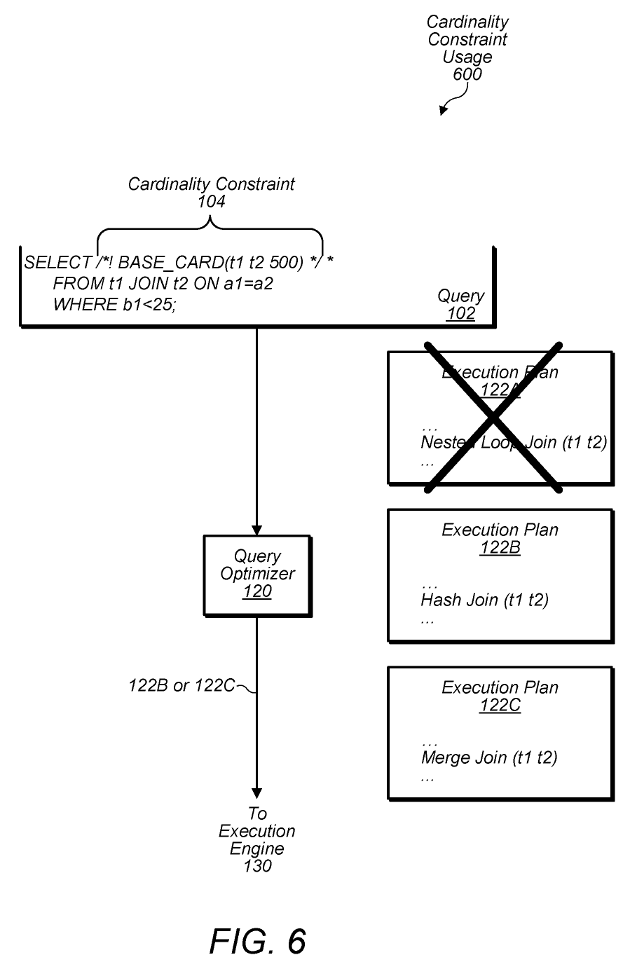

Query optimizer 120, in various embodiments, is operable to generate an execution plan 112 for a given query 102, which includes evaluating various execution plans 122 and selecting one to implement the query 102. Optimizer 120 may use any suitable algorithm to evaluate and select plans 122. In some embodiments, optimizer 120 may use a heuristic algorithm in which execution plans 122 are assessed based on a set of rules provided to optimizer 120. In other embodiments, optimizer 120 uses a cost-based algorithm in which optimizer 120 performs a cost analysis that includes assigning scores to execution plans 122 based on an estimated processor consumption, an estimated memory consumption, an estimated execution time, etc. These estimates may further be based on various metrics such as the number of distinct values in table columns, the selectivity of predicates (the fraction of rows the predicate would qualify), the cardinalities (e.g., row counts) of tables 140A being accessed as will be discussed with respect to FIG. 6, etc. Based on the scores, optimize 120 may then select an execution plan 122 that has the best score. In still other embodiments, optimizer 120 may use a combination of heuristic and cost-based algorithms.

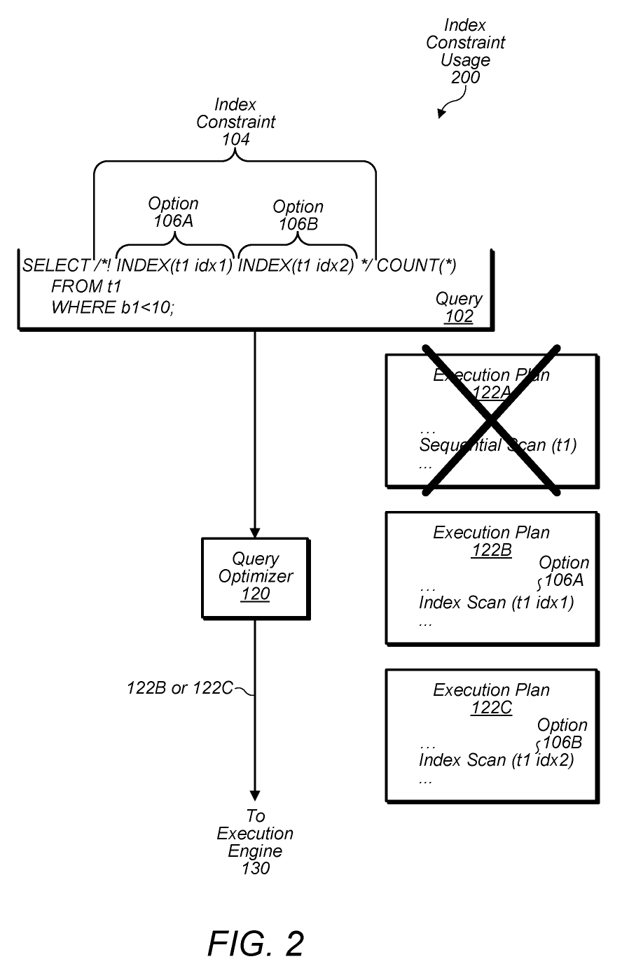

As discussed above, in various embodiments, query optimizer 120 is further operable to evaluate execution plans 122 based on constraints 104 included in a query 102 and select plans 122 that comply with constraints 104. For example, in some embodiment, a query optimizer 120 may assign an unfavorable score to (or may not even score) any execution plan 122 that does not comply with constraints 104 in order to preclude it from being selected. As noted above and shown in FIG. 1, in various embodiments, a given constraint 104 may specify multiple options 106 for an acceptable execution plan 122. For example, as will be described below with respect to FIG. 2, the constraint 104 depicted in FIG. 1 instructs optimizer 120 to select a plan 122 that includes an index scan using index idx1 (depicted as option 106A) or an index scan using index idx2 (depicted as option 106B) in order to implement query 102. (Although two options 106A and 106B are depicted in FIG. 1 and some subsequent Figs., any number of options 106 may be specified in various embodiments.) Thus, optimizer 120 may consider, for selection, plans 122 that include option 106A and plans 122 that include option 106B, but not consider any plans 122 that do not possess either of options 106A and 106B (e.g., a plan 122 that does not include an index scan). Various examples of constraints 104 will be discussed in greater detail below with respect to FIGS. 2-6. These constraints 104 may, for example, include constraints that restrict how scans are performed, restrict how joins are performed, override metrics assessed by optimizer 120, etc.

In various embodiments, if query optimizer 120 is unable to select an execution plan 122 that satisfies the constraints 104 for a given query 102, query optimizer 120 is operable to provide a corresponding indication shown as an error 124 in FIG. 1. In some embodiments, this error 124 may indicate not only that a plan 122 does not exist to satisfy constraints 104, but also identify the particular constraint 104 that could not be satisfied if multiple constraints 104 were specified in the query 102. In some embodiments, query optimizer 120 may still select an execution plan 122 (albeit one that does not comply with constraints 104) and provide it to plan execution engine 130—thus, a user may still receive results 132, but be made aware that the results 132 were obtained in a manner that is inconsistent with the provided constraints 104. In other embodiments, however, query optimizer 120 may provide an error 124 and not select any plan 122 to implement the query 102.

Once an execution plan 122 has been selected, execution engine 130, in various embodiments, is operable to execute the selected plan 122. Accordingly, engine 130 may perform the various actions listed in the plan 122, which may include accessing one or more data tables 140A, indexes 140B, and/or temporary tables 140C. Engine 130 may then return any results 132 to service query 102.

Turning now to FIG. 2, a block diagram of an index constraint usage 200 is depicted. As shown, database system 10 may receive a request for a query 102 that selects, from a table, content that satisfies one or more criteria. In the particular query 102 depicted in FIG. 2, a request is made to select rows from table t1 that have a value in column b1 less than 10, and to count the number of selected rows. When such a query 102 is received, database system 10 may support multiple types of scan operations for identifying rows that meet the specified criteria. For example, database system 10 may support a sequential scan in which execution engine 130 walks row by row examining each value in column b1 and determining whether it is less than 10. Database system 10 may also support an index scan in which an index is referenced to identify particular rows of interested. For example, an index 140B may exist that maps a given value to each row having that value in column b1. Accordingly, using index scan based on this index may be more efficient as rows having, for example, the values of 9, 8, 7, and so forth can be identified using the index without having to consider rows having values greater than 10.

In the illustrated embodiment, query optimizer 120 supports an index constraint 104 that instructs query optimizer 120 to select a plan 122 that includes one of multiple options 106 for index scans. In the specific example depicted in FIG. 2, option 106A “INDEX (t1 idx1)” indicates that an index scan using table t1's index idx1 would be acceptable. Option 106B “INDEX (t2 idx2)” indicates that an index scan using table t1's index idx2 would also be acceptable. Accordingly, based on these two options 106A and 106B, query optimizer 120 may not consider an execution plan 122A including a sequential scan t1, and instead evaluates an execution plan 122B including option 106A and an execution plan 122C having option 106B. Based on this evaluation, optimizer 120 then selects a preferred one of plans 122B and 122C for execution by execution engine 130.

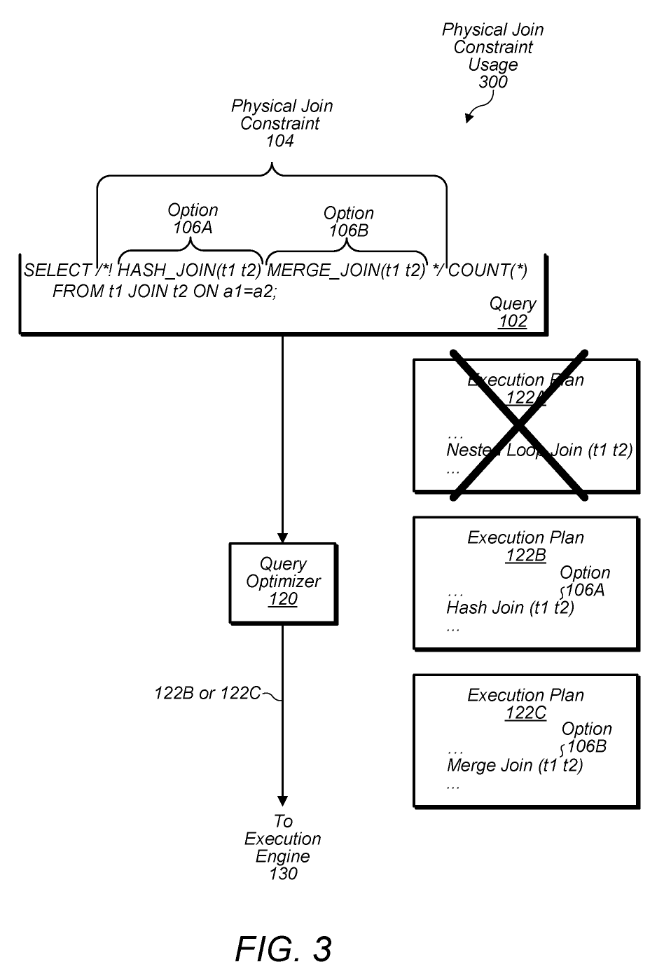

Turning now to FIG. 3, a block diagram of a physical join constraint usage 300 is depicted. As shown, a query 102 may be received that requests the joining of content from two or more tables. In the particular query 102 depicted in FIG. 3, a request is made to join together rows of table t1 and t2 if a value in column a1 of t1 matches a value in column a2 of t2.

The expression of a join in a query may be referred to herein as a “logical join.” A logical join stands in contrast to a “physical join,” which is the operation performed by execution engine 130 to implement the logical join. In various embodiments, database system 10 supports multiple types of physical joins such as a “nested loop join,” “hash join,” and “merge join.” As used herein, the phase “nested loop join” is to be interpreted in accordance with its ordinary and established meaning, which includes a join in which each element in the right relation (or left relation) is scanned once for every row found in the left relation (or right relation). For example, each value in column a1 would be scanned against every value in column a2. As used herein, the phrase “hash join” is to be interpreted in accordance with its ordinary and established meaning, which includes a join in which 1) the right relation (or left relation) is first scanned and loaded into a hash table, using its join attributes as hash keys and 2) the left relation (or right relation) is scanned and the appropriate values of every row found are used as hash keys to locate the matching rows in the table. As used herein, the phrase “merge join” is to be interpreted in accordance with its ordinary and established meaning, which includes a join in which 1) each relation is sorted on the join attributes before the join starts, 2) the two relations are scanned in parallel, and 3) matching rows are combined to form join rows.

In the illustrated embodiment, query optimizer 120 supports a physical join constraint 104 that instructs query optimizer 120 to select a plan 122 that includes one of multiple types of physical joins indicated by options 106. In the specific example depicted in FIG. 3, option 106A “HASH_JOIN (t1 t2)” indicates a desire for a hash join of tables t1 and t2. Option 106B “MERGE_JOIN (t1 t2)” indicates a desire for a merge join of tables t1 and t2. Accordingly, based on these two options 106A and 106B, query optimizer 120 may not consider an execution plan 122A including a nested loop join of tables t1 and t2, and instead evaluates an execution plan 122B including a hash join corresponding to option 106A and an execution plan 122C including a merge join corresponding to option 106B. Based on this evaluation, optimizer 120 then selects a preferred one of plans 122B and 122C for execution by execution engine 130.

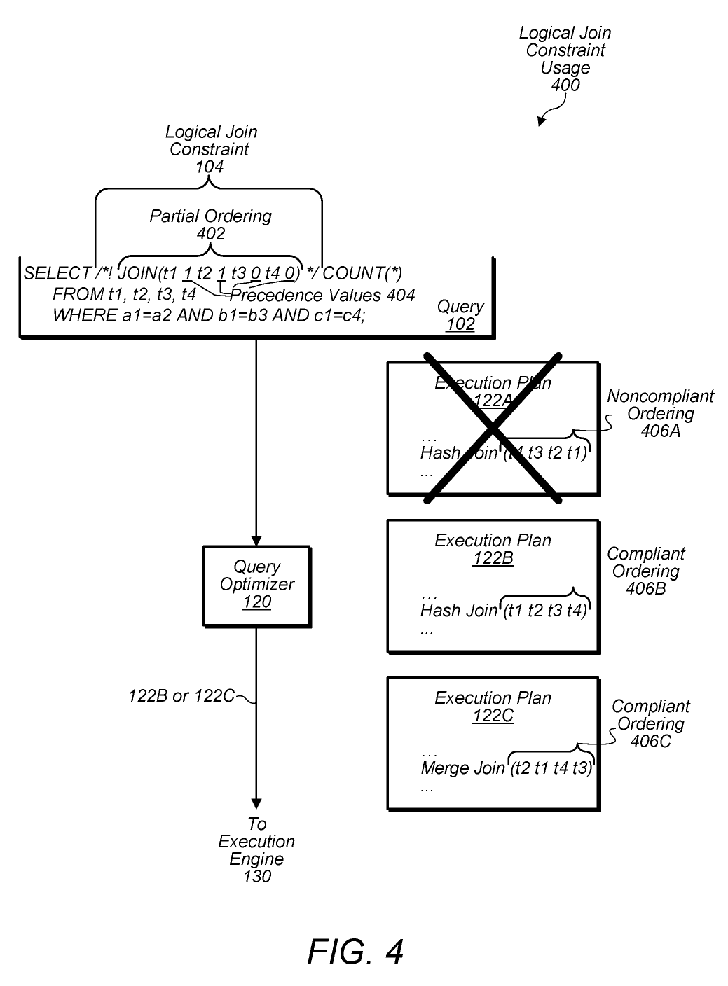

Turning now to FIG. 4, a block diagram of a logical join constraint usage 400 is depicted. As discussed above in the background, a join between three or more tables may be implemented using multiple different orderings. In some embodiments, query optimizer 120 supports a logical constraint 104 in which a partial ordering 402 can be expressed to optimizer 120 without expressing the entire ordering for joining tables—thus allowing optimizer to choose between multiple ordering options.

In the illustrated embodiment, partial ordering 402 is expressed using a grammar in which precedence values 404 are assigned to tables being joined. (In other embodiments, different grammars may be used to express partial orderings 402.) For example, as shown, tables t1 and t2 are assigned a precedence value of 1 while tables are assigned a precedence value 0. In some embodiments, tables assigned a greater precedence value are performed earlier; however, tables assigned the same value may be performed in any ordering. According, in such an embodiment, tables t1 and t2 having the value 1 are to be ordered earlier in the join than tables t3 and t4 having the value 0; however, either table t1 or table t2 may be the initial table in the ordering. Thus, the ordering 406B of t1, t2, t3, and t4 and the ordering 406C of t2, t1, t4, t3 are compliant with partial ordering 402 depicted in FIG. 4. The ordering 406A of t4, t3, t2, and t1, however, is not compliant as tables t4 and t3 have a lower precedence value than the precedence value of tables t1 and t2, in this example. As a result, query optimizer 120 may not consider an execution plan 122A having a noncompliant ordering 406A, and evaluate only those plans 122B and plans 122C having compliant orderings 406B and 406C.

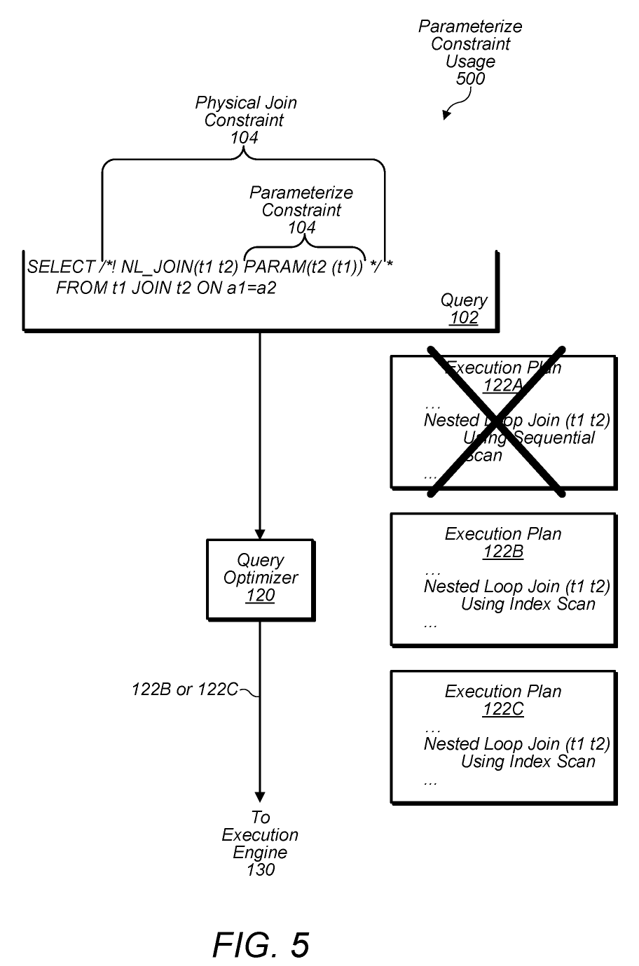

Turning now to FIG. 5, a block diagram of a parameterize constraint usage 500 is depicted. As noted above with FIG. 3, a query 102 may include physical join constraint 104 indicating the type of physical join to be used to implement a join specified in the query 102. In instances in which a nested loop join is specified, the nested loop join may be implemented using a sequential scan or an index scan.

In some embodiments, query optimizer 120 supports a parameterize constraint 104 to indicate that index scan is to be used. In the specific example depicted in FIG. 5, “PARAM(t2 (t1))” indicates that the values of t1 are to be parameterized and supplied to an index for t2 to identify the corresponding rows of the join. For example, suppose t1 has the values 1, 2, and 3 for a1. When the index scan is performed, t1 is scanned such that the value 1 for a1 becomes the index scan predicate input into the index of t2 for column a2. The matching rows are then formed and output by the nested loop join. This process is then repeated for the a1 values 2 and 3. Because the values are substituted in the predicate on the index scan this type of plan is referred to as a parameterized plan.

Turning now to FIG. 6, a block diagram of a cardinality constraint usage 600 is depicted. As noted above, the cardinality of a table 140 (i.e., the size of a table) may affect query optimizer 120′s evaluation of various execution plans 122A. In the some embodiments, the cardinality of a table can be expressed to the optimizer 120 by providing a cardinality constraint 104 in a query 102 (as opposed to having optimizer 120 read the cardinality from a database catalog). For example, as shown in FIG. 6, the cardinality constraint 104 “BASE_CARD(t1 t2 500)” indicates that tables t1 and t2 include 500 rows. Notably, in the illustrated embodiment, the same constraint 104 is used to specify cardinalities for multiple tables being accessed for the query 102. Based on this information, query optimizer 120 may determine to not consider an execution plan 122A in which a nested loop join is performed if the 99 rows are sufficiently large enough, in this example, to make the nested loop join undesirable. Instead, query optimizer 120 may select execution plan 122B including a hash join or execution plan 122C including a merge join as these physical joins may be more efficient for the size of table t1. In some embodiments, query optimizer 120 also supports a cardinality constraint 104 that indicates the cardinality of a table generated as a result of query 102. For example, in the query 102 depicted in FIG. 6, inclusion of the constraint 104 “CARD(t1 99)” may indicate to optimizer 120 that the table generated from the join of t1 and t2 is to have 99 rows. Based on this information, optimizer 120 may choose a different execution plan 122.

Turning now to FIG. 7, a block diagram of a plan constraint merger 700 is depicted. As noted above and shown in FIG. 7, a query 102A may be received that includes another query 102B. Still further, queries 102A and 102B may include multiple constraints 104A and 104B, respectively. In the illustrated embodiment, parser 110 is operable to identify these nested queries 102 and determine whether they can be merged together. (In another embodiment, this analysis may be performed by query optimizer 120.) Based on this determination, parser 110 may produce a single merged query 102C from queries 102A and 102B as well as a single merged constraint 104C from constraints 104A and 104B.

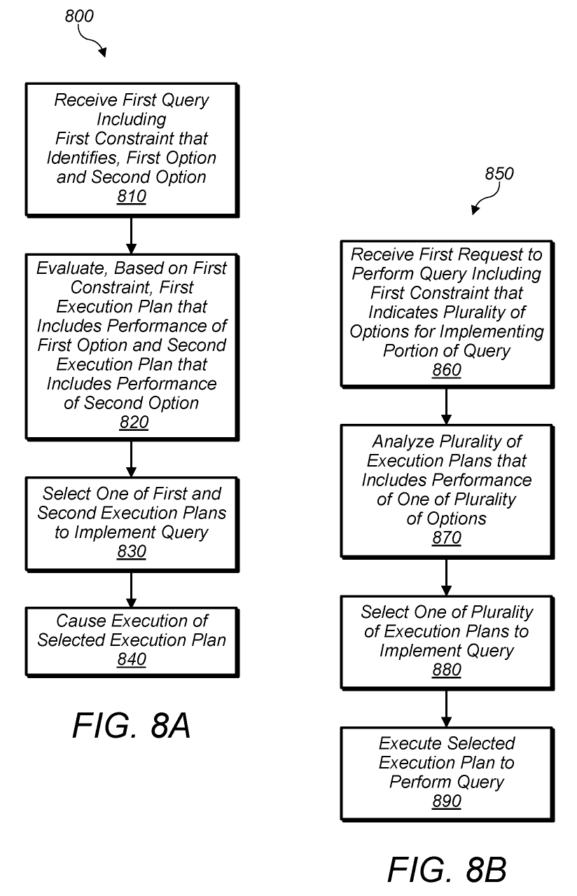

Turning now to FIG. 8A, a flowchart of a method 800 for performing a database query is shown. In one embodiment, method 800 is performed by query optimizer of a database system such as query optimizer 120. In some instances, performance of method 800 allows greater user control and better execution plans to be potentially selected.

In step 810, a first query (e.g., query 102) including a first constraint (e.g., a constraint 104) that restricts selection of a set of execution plans (e.g., execution plans 122) available to implement the first query is received. In various embodiments, the first constraint identifies, at least, a first option (e.g., option 106A) and a second option (e.g., option 106B) to implement a clause in the first query. In some embodiments, the clause requests selection of data from the database system (e.g., the SQL SELECT in index constraint usage 200), the first option identifies a first index to be used in performing the selection, and the second option identifies a second index to be used in performing the selection. In some embodiments, the clause requests joining content from a plurality of tables in the database system (e.g., the SQL JOIN in physical join constraint usage 300), the first option is a first type of join operation (e.g., a hash join) executable to join the content, and the second option is a second type of join (e.g., a merge join) operation executable to join the content. In some embodiments, the clause requests joining content from a plurality of tables in the database system (e.g., the SQL JOIN in logical join constraint usage 400), the first option is a first ordering (e.g., ordering 404A) for joining content from the plurality of tables, and the second option is a second ordering (e.g., ordering 404B) for joining content from the plurality of tables.

In step 820, a first execution plan that includes performance of the first option and a second execution plan that includes performance of the second option are evaluated based on the first constraint.

In step 830, one of the first and second execution plans to implement the first query is selected based on the evaluating.

In step 840, execution of the selected execution plan is caused. In various embodiments, the causing includes the query optimizer providing the selected execution plan to an execution engine for execution.

In some embodiments, method 800 further includes receiving a second query including a second constraint (e.g., a parameter constraint 104), the second query requesting a join operation, and the second constraint indicating that the join operation is to be implemented with a nested loop join that uses an index. In such an embodiment, method 800 includes evaluating, based on the second constraint, execution plans that include performance of the nested loop join using the index. In some embodiments, method 800 includes receiving a second query including a second constraint (e.g., cardinality constraint 104), the second constraint identifying a cardinality of a table specified in the second query. In such an embodiment, method 800 includes evaluating a plurality of execution plans based on the identified cardinality. In some embodiments, the first query (e.g., including constraint 104A) includes a second query that includes a second constraint (e.g., constraint 104B), and method 800 includes merging the first and second queries into a single query, including merging the first and second constraints into a single constraint (e.g., merged constraint 104C). In some embodiments, method 800 includes receiving a second query including a second constraint, determining, by the query optimizer, that no execution plan satisfying the second constraint exists, and, in response to the determining, providing an indication (e.g., an error 124) that the query optimizer is not able to determine an execution plan that satisfies the second constraint. In some embodiments, method 800 further includes selecting another execution plan that does not satisfy the second constraint and causing execution of the other selected execution plan.

Turning now to FIG. 8B, a flowchart of a method 850 for performing a database query is shown. In one embodiment, method 800 is performed by query optimizer of a database capable of receiving optimizer constraints such as a database implanted by database system 10. In some instances, performance of method 800 allows greater user control and better execution plans to be potentially selected.

Method 850 begins in step 860 with receiving a first request to perform a query (e.g., query 102) of the database, the first request including a first constraint (e.g., constraint 104) that indicates a plurality of options (e.g., options 106) for implementing a portion of the query. In some embodiments, the first constraint (e.g., index constraint 104) indicates that the query is to be performed using one of at least two indexes specified in the first constraint. In some embodiments, the first constraint (e.g., physical join constraint 104) indicates that a join specified in the first request is to be performed using one of at least two physical join operations specified in the first constraint. In some embodiments, the first constraint (e.g., logical join constraint 104) indicates that a join specified in the first request is to be performed using one of at least two orderings for joining tables permitted by the first constraint. In step 870, a plurality of execution plans that include performance of at least one of the plurality of options are analyzed. In step 880, based on the analyzing, one of the plurality of execution plans is selected to implement the query. In step 890, the selected execution plan is executed to perform the query. In some embodiments, method 850 further includes receiving a second request to perform a query of the database, the second request including a second constraint and indicating (e.g., via an error 124), to a user of the database, that the second constraint cannot be satisfied.

### Exemplary Computer System

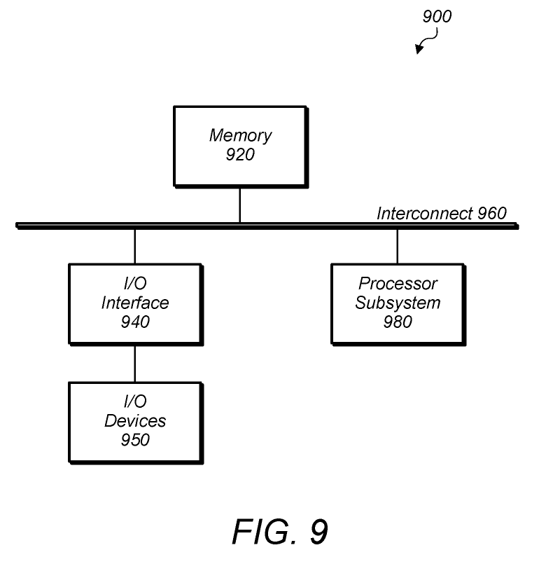

Turning now to FIG. 9, a block diagram of an exemplary computer system 900, which may implement database system 10, is depicted. Computer system 900 includes a processor subsystem 980 that is coupled to a system memory 920 and I/O interfaces(s) 940 via an interconnect 960 (e.g., a system bus). I/O interface(s) 940 is coupled to one or more I/O devices 950. Computer system 900 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 900 is shown in FIG. 9 for convenience, system 900 may also be implemented as two or more computer systems operating together.

Processor subsystem 980 may include one or more processors or processing units. In various embodiments of computer system 900, multiple instances of processor subsystem 980 may be coupled to interconnect 960. In various embodiments, processor subsystem 980 (or each processor unit within 980) may contain a cache or other form of on-board memory.

System memory 920 is usable store program instructions executable by processor subsystem 980 to cause system 900 perform various operations described herein. System memory 920 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 900 is not limited to primary storage such as memory 920. Rather, computer system 900 may also include other forms of storage such as cache memory in processor subsystem 980 and secondary storage on I/O Devices 950 (e.g., a hard drive, storage array, etc.). In some embodiments, these other forms of storage may also store program instructions executable by processor subsystem 980. In some embodiments, portions of database system 10 described above may include (or be included within) system memory 920.

I/O interfaces 940 may be any of various types of interfaces configured to couple to and communicate with other devices, according to various embodiments. In one embodiment, I/O interface 940 is a bridge chip (e.g., Southbridge) from a front-side to one or more back-side buses. I/O interfaces 940 may be coupled to one or more I/O devices 950 via one or more corresponding buses or other interfaces. Examples of I/O devices 950 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 900 is coupled to a network via a network interface device 950 (e.g., configured to communicate over WiFi, Bluetooth, Ethernet, etc.).

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A non-transitory computer readable medium having program instructions stored thereon that are capable of causing a computing system to implement operations comprising:
receiving, by a query optimizer of a database system, a first query including a first constraint that restricts selection of a set of execution plans available to implement the first query, wherein the first constraint identifies, at least, a first option and a second option to implement a clause in the first query;
evaluating, by the query optimizer and based on the first constraint, a first execution plan that includes performance of the first option and a second execution plan that includes performance of the second option;
based on the evaluating, selecting, by the query optimizer, one of the first and second execution plans to implement the first query; and
causing, by the query optimizer, execution of the selected execution plan.

2. The computer readable medium of claim 1, wherein the clause requests selection of data from the database system, wherein the first option identifies a first index to be used in performing the selection, and wherein the second option identifies a second index to be used in performing the selection.

3. The computer readable medium of claim 1, wherein the clause requests joining content from a plurality of tables in the database system, wherein the first option is a first type of join operation executable to join the content, and wherein the second option is a second type of join operation executable to join the content.

4. The computer readable medium of claim 3, wherein the first type of join operation is a hash join, and wherein the second type of join operation is nested loop join.

5. The computer readable medium of claim 1, wherein the clause requests joining content from a plurality of tables in the database system, wherein the first option is a first ordering for joining content from the plurality of tables, and wherein the second option is a second ordering for joining content from the plurality of tables.

6. The computer readable medium of claim 1, wherein the operations further comprise:
receiving, by the query optimizer, a second query including a second constraint, wherein the second query requests a join operation, and wherein the second constraint indicates that the join operation is to be implemented with a nested loop join that uses an index; and
evaluating, by the query optimizer and based on the second constraint, execution plans that include performance of the nested loop join using the index.

7. The computer readable medium of claim 1,
receiving, by the query optimizer, a second query including a second constraint, wherein the second constraint identifies a cardinality of a table specified in the second query; and
evaluating, by the query optimizer, a plurality of execution plans based on the identified cardinality.

8. The computer readable medium of claim 1, wherein the first query includes a second query that includes a second constraint; and
wherein the operations further comprise:
merging the first and second queries into a single query, including merging the first and second constraints into a single constraint.

9. The computer readable medium of claim 1, wherein the operations further comprise:
receiving, by the query optimizer, a second query including a second constraint;
determining, by the query optimizer, that no execution plan satisfying the second constraint exists; and
in response to the determining, providing an indication that the query optimizer is not able to determine an execution plan that satisfies the second constraint.

10. The computer readable medium of claim 9, wherein the operations further comprise:
selecting, by the query optimizer, another execution plan that does not satisfy the second constraint; and
causing, by the query optimizer, execution of the other selected execution plan.

11. A method, comprising:
receiving, by a query optimizer of a database system, a first query including a first constraint that specifies a plurality of options for implementing an execution plan for the first query;
performing, by the query optimizer, an analysis evaluating a plurality of execution plans corresponding to the plurality of options;
based on the analysis, selecting, by the query optimizer, one of the plurality of execution plans to implement the first query; and
providing, by the query optimizer, the selected execution plan to an execution engine of the database system to execute the selected execution plan.

12. The method of claim 11, wherein the first constraint indicates that the selected execution plan is to include an index scan based on one of at least two indexes identified in first constraint.

13. The method of claim 11, wherein the first constraint indicates that the selected execution plan is to include one of at least two types of physical join operations identified in first constraint.

14. The method of claim 11, wherein the first constraint indicates that the selected execution plan is to perform a joining of tables in an ordering that is at least partially specified in the first constraint.

15. The method of claim 11, further comprising:
receiving a second query including a second constraint that specifies a plurality of options for implementing an execution plan for the second query; and
providing, by the database system, an error message indicating that an execution plan cannot be determined for the second constraint.

16. A computer system, comprising:
one or more processors;
memory having program instructions stored therein that are executable by the one or more processors to implement a database performing operations including:
receiving a first request to perform a query of the database, wherein the first request includes a first constraint that indicates a plurality of options for implementing a portion of the query;
analyzing a plurality of execution plans that include performance of at least one of the plurality of options;
based on the analyzing, selecting one of the plurality of execution plans to implement the query; and
executing the selected execution plan to perform the query.

17. The computer system of claim 16, wherein the first constraint indicates that the query is to be performed using one of at least two indexes specified in the first constraint.

18. The computer system of claim 16, wherein the first constraint indicates that a join specified in the first request is to be performed using one of at least two physical join operations specified in the first constraint.

19. The computer system of claim 16, wherein the first constraint indicates that a join specified in the first request is to be performed using one of at least two orderings for joining tables permitted by the first constraint.

20. The computer system of claim 16, wherein the operations further comprise:
receiving a second request to perform a query of the database, wherein the second request includes a second constraint; and
indicating, to a user of the database, that the second constraint cannot be satisfied.
